(19) United States
(12) Patent Application Publication
(10) Pub. No.: US 2003/0086706 A1
(43) Pub. Date: May 8, 2003

(54) Image photographing apparatus, order sheet, and order processing apparatus and method

(75) Inventor: Naoto Kinjo, Kanagawa (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/254,876

(22) Filed: Sep. 26, 2002

(30) Foreign Application Priority Data
Sep. 28, 2001 (JP) 2001-303582

(51) Int. Cl. G03B 17/00

(52) U.S. Cl. 396/420; 348/207.99

(57) ABSTRACT

When a cameraman photographs a customer by a DSC, an order sheet in which the identification code of a photographed image is written into an IC chip mounted on a sheet and on which the photographed image is also recorded is produced by the DSC, and it is handed to the customer. In ordering the photographed image, the customer goes to a place where an order receiving terminal is installed, and he/she inserts the sheet into the slit of an order sheet reading unit. Thus, the identification code is read, and the whole surface of the sheet is read by a scanner, whereupon the read results are transmitted to an order processing apparatus. The order processing apparatus extracts corresponding image data from an image DB, with the identification code used as a key, and it performs a process complying with the customer's order.

### BACKGROUND OF THE INVENTION

1. Field of the Invention

The present invention relates to an image photographing apparatus, an order sheet, and an order processing apparatus and method, and in particular, to an image photographing apparatus which can photograph any person desired as a subject, an order sheet which a customer can utilize for ordering an image, and an order processing apparatus and an order processing method which process an order for an image from a customer.

2. Description of the Related Art

When a photographer goes out to a sight-seeing place, a theme park or the like while carrying a photographing device such as camera, to take a commemorative shot or the like in a major place. Even when the photographer carries a tripod or the like together with the camera, images in which the photographer himself/herself is photographed as a subject are liable to become few in number because the setting of the camera and the tripod is troublesome and the like. Further, much difficulty is often involved in photographing in case of, for example, taking a shot of a scene where a specific attraction in the theme park is being enjoyed. In this case, only companions participate in the attraction as subjects, whereas the photographer devotes himself/herself to the photographing without participating in the attraction.

As a technique for eliminating the above drawbacks, it has heretofore been practiced that, for example, the participants in the specified attraction of the theme park are automatically photographed, that photographed images are presented to the participants forming the subjects of the images, at the exit of the specified attraction, and that photographic prints are produced and delivered to the participants (customers) when orders are given by the participants. In the sight-seeing place or the like, a cameraman photographs unspecified sightseers, and that the photographic prints of photographed images are presented at or near the exit or the like of the sight-seeing place so as to be purchasable by the sightseers (customers), who are the subjects of the images.

With the above techniques, however, each of the customers needs to search the plurality of presented images for a desired image (for example, an image in which the customer himself/herself is photographed as the subject). This incurs the disadvantage that a burden to the customer for searching for the desired image increases as the number of the presented images increases. Moreover, the customer is often short of time to-spare for appreciating the desired image or for considering whether or not the image is to be ordered, because the place for presenting the images to the customers is crowded or because the customer himself/herself has limited time. This might lead to decrease in the customer's will to purchase the photographed image.

### SUMMARY OF THE INVENTION

The present invention has been made in consideration of the above facts, and an object of the invention is to provide an image photographing apparatus, an order sheet, an order processing apparatus and an order processing method which can afford a customer a sufficient time period for confirming an image, etc., when the customer orders the image which has not been photographed by himself/herself.

An image photographing apparatus according to the first aspect of the invention for accomplishing the above object is characterized by comprising a photographing component; and an order sheet producing component for producing an order sheet, which is usable by the customer to order a photographed image, by printing an image, which was obtained by being photographed by the photographing component, on a predetermined sheet; wherein, the order sheet producing component records, on the predetermined sheet, identification information for identifying the photographic image, or further comprises an information adding component for reading out identification information stored in advance on the predetermined sheet and adding the identification information to image data of the image, which was obtained by the photographing of the photographic component.

The image photographing apparatus according to the first aspect comprises the order sheet producing component which prints the image obtained by the photographing with the photographing component, on the predetermined sheet, thereby to produce the order sheet which the customer can utilize for ordering the photographed image. Further, in the invention of claim 1, identification information for identifying the photographed image is recorded on the predetermined sheet by the order sheet producing component, or identification information recorded on the predetermined sheet in advance is read out by the information adding component so as to be added to image data of the image obtained by the photographing based on the photographing component.

Thus, each time a cameraman in possession of the image photographing apparatus according to the first aspect photographs any desired subject in any desired place by way of example, the order sheet on which the image obtained by the photographing is printed is produced, and the cameraman can provide the produced order sheet to a customer who is present in the place (for example, a customer who has been photographed as a subject). Then, the customer can check the content of the photographed image by referring to the image printed on the delivered order sheet.

In the first aspect, the order for the photographed image may well be given immediately after the photographing. In the invention defined in claim 1, however, the identification information for identifying the photographed image is recorded on the predetermined sheet (order sheet) by the order sheet producing component, or the identification information recorded on the predetermined sheet (order sheet) beforehand is added to corresponding image data by the order sheet producing component. Therefore, in a case where image data obtained by the photographing is stored in a storage device, the image data of the image (image to-be-ordered) can be easily specified on the basis of the identification information recorded on the order sheet possessed by the customer, and the customer's order can be complied with, even if a certain period has lapsed since the photographing.

Accordingly, in accordance with the first aspect, the order for the image need not be given immediately after the photographing, and the customer can order the image after sufficiently ascertaining the image printed on the delivered order sheet and reaching the conclusion of ordering the image. Therefore, in ordering the image which has not been photographed by the customer himself/herself, the customer is permitted to be given a sufficient time for the check of the image, etc.

Incidentally, a known recording scheme, for example, ink jet scheme or thermal transfer scheme can be applied to printing the photographed image on the predetermined sheet. Further, the invention is not restricted to the case of recording the single image on the single sheet, but a plurality of images may well be recorded on the single sheet in the existence of a plurality of images which the customer might order.

Further, the image data of the image obtained by the photographing based on the photographing component in the second aspect can be stored in the storage device of an order processing apparatus in such a way that it is once recorded in a recording medium (for example, SMART MEDIA™, COMPACT FLASH™ or MEMORY STICK™), and that it is thereafter read out of the recording medium by the order processing apparatus or transmitted to the order processing apparatus.

Further, in a third aspect, the order sheet producing component can record the identification information on the predetermined sheet or record the identification information on the predetermined sheet beforehand in such a way that the identification information is recorded in or on an IC chip or a magnetic medium mounted on the predetermined sheet beforehand, or that a code (for example, a bar code or any other code) expressive of the identification information is recorded on the predetermined sheet.

Further, in the first aspect, considering the fact that the order sheet produced by the order sheet producing component is delivered to the customer forming the subject, on the occasion of the photographing, the producing of the order sheet needs to be completed in a short time. As a forth aspect, therefore, the order sheet producing component should preferably degrade an image quality of the image data obtained by the photographing based on the photographing component (for example, lower the resolution of the image data or decrease the number of the gradations of the image data, decrease the number of colors or make the image monochromatic, make the image a line drawing, or simplify the image to an animation touch) and then print the photographed image on the predetermined sheet by using the image data subjected to the image quality degradation. In general, when the image quality of image data is degraded, a size of information decreases, and it is possible to speed up printing, so that a time period for creating the order sheet can be shortened.

Further, as a fifth aspect, the predetermined sheet may well be constructed including an electronic display medium (for example, electronic paper (refer to JP-A No. 11-502950, etc.)) which can electronically retain and visibly display the written image and which can rewrite the retained image. In this case, the order sheet producing component should desirably be constructed so as to write the image obtained by the photographing based on the photographing component, into the electronic display medium of the predetermined sheet. Since the electronic display medium can rewrite the retained image (display image), it is also permitted to reuse the predetermined sheet by rewriting the image once written into the electronic display medium.

As a sixth aspect, an order sheet has the image, which was obtained by photographing with the photographing component of the image photographing apparatus of claim 1, recorded there on by the image sheet producing component of the image photographing apparatus, and has one of identification information for identifying the photographed image recorded thereon by the order sheet producing device, and identification information for being added to the image data of the photographed image, which identification information is recorded in advance, read out therefrom by the information adding component. Therefore, the customer to whom the order sheet has been delivered need not order the image immediately after the photographing, but he/she can order the image after sufficiently ascertaining the image printed on the delivered order sheet and reaching the conclusion of ordering the image. As in the invention defined in claim 1, accordingly, in ordering the image which has not been photographed by the customer himself/herself, the customer is permitted to be given a sufficient time for the check of the image, etc.

As a seventh aspect, an order processing apparatus is constructed comprising a storage device in which image data obtained by photographing any person as a subject with an image photographing apparatus is stored; an acquisition component which acquires information for specifying an image ordered by a customer, from an order sheet, when the image obtained by the photographing is ordered by the customer possessing the order sheet which has been produced by printing the image on a predetermined sheet and then delivered to the customer on the occasion of the photographing; and a processing component which performs a predetermined process complying with the customer's order for the image, by using the image data of the ordered image specified by the information acquired by the acquisition component, among the image data stored in the storage device.

In the seventh aspect, the image data obtained by photographing any desired person as the subject with the image photographing apparatus is stored in the storage device. Incidentally, the acquisition of the image data obtained by the photographing can be incarnated in the way stated before that the image data once recorded in the recording medium by the image photographing apparatus is read out of the recording medium, or that the image data transmitted by the image photographing apparatus is received.

Further, in the seventh aspect, the order sheet produced by printing the image obtained by the photographing, on the predetermined sheet, is delivered to the customer on the occasion of the photographing, and the information for specifying the image ordered by the customer is acquired from the order sheet by the acquisition component when the image is ordered by the customer possessing the order sheet. Further, the processing component according to the sixth aspect performs the predetermined process complying with the customer's order for the image, by using the image data of the ordered image specified by the information acquired by the acquisition component, among the image data stored in the storage device.

In this manner, according to the seventh aspect, the information for specifying the image ordered by the customer is acquired from the order sheet. Therefore, even when a certain period has lapsed since the photographing, the image data of the ordered image can be specified with ease, and the customer's order can be complied with. As in the first aspect, accordingly, the order for the photographed image need not be given immediately after the photographing, and the customer can order the image after sufficiently ascertaining the photographed image printed on the provided order sheet and reaching the conclusion of ordering the image. Therefore, in ordering the image which has not been photographed by the customer himself/herself, the customer is permitted to be given a sufficient time for the check of the image, etc.

As an eighth aspect, in a case where the image photographing apparatus is one defined in the first aspect, the acquisition component can be constructed so that the identification information recorded on the order sheet (identification information recorded by the order sheet producing component, or recorded on the predetermined sheet beforehand) may be read, thereby to acquire the information for specifying the ordered image. In this case, the ordered image can be easily specified on the basis of the acquired identification information.

Also, in a case where the identification information is recorded in an IC chip mounted on the predetermined sheet beforehand, by way of example, it can be electrically read from the IC chip. Further, in a case where the identification information is recorded on a magnetic medium mounted on the predetermined sheet beforehand, by way of example, it can be magnetically read from the magnetic medium. Further, in a case where a code expressive of the identification information is recorded on the predetermined sheet by way of example, the identification information can be acquired by optically reading the code.

Further, in a ninth aspect, the acquisition component may well read the order sheet or receive the read result of the order sheet by a reading component, thereby to acquire the read result of the order sheet as the information for specifying the ordered image. The reading of the order sheet can be done by, for example, an image scanner. Further, in the aspect in which the read result of the order sheet by the reading component is received, the image scanner of a facsimile equipment, for example, can be applied as the reading component, and the read result of the order sheet can be received in such a way that the customer transmits the read result by employing the facsimile equipment.

In this case, the processing component can specify the ordered image by analyzing the acquired read result of the order sheet. The analysis of the read result of the order sheet and the specification of the ordered image may well be concretely performed, for example, in such a way that the data of an area corresponding to the image printed on the sheet is extracted from the read result of the order sheet, whereupon the image expressed by the extracted data is collated with each of images expressed by image data as stored in the storage device, or in such a way that the feature quantity of the image expressed by the extracted data is calculated, whereupon the calculated feature quantity is compared with the feature quantity of each of the images expressed by the image data as stored in the storage device.

In the ninth aspect, the ordered image needs to be specified by analyzing the read result of the order sheet, and hence, the processing becomes somewhat complicated. Since, however, the identification information need not be recorded on the order sheet on the occasion of the photographing, it is permitted to shorten a time period required for the producing of the order sheet.

As a tenth aspect, in a case where the contents of the customer's order (for example, the number and sizes of images, and a range to be trimmed) are written onto the order sheet by handwriting by the customer, it is favorable that the acquisition component reads the order sheet on which the order contents are written by handwriting or receives the read result of the order sheet as read by a reading component, whereupon it analyzes the read result of the order sheet, thereby to acquire the information expressive of the customer's order contents, and that the processing component performs the predetermined process on the basis of the information expressive of the customer's order contents as acquired by the acquisition component.

Thus, the customer is permitted to write the order contents by handwriting and to easily give his/her order. Moreover, since the order contents written by handwriting are automatically recognized, labor for receiving the customer's order can be stored.

Further, mentioned as the predetermined process in a eleventh aspect is a process for creating a print or for making a request for the producing of the print, by using the image data of the ordered image among the image data stored in the storage device, or a process for delivering or transmitting the image data of the ordered image to the customer. By the way, in delivering or transmitting the image data to the customer, predetermined image processing (for example, scale-up/down, trimming, or image processing for enhancement in an image quality) may well be performed.

As a twelfth aspect, an order processing method comprises providing an order sheet to a customer who forms a subject of an image, the order sheet being produced in such a way that when any person is photographed as the subject, the image obtained by the photographing is printed on a predetermined sheet, and also saving image data obtained by the photographing, in a storage device beforehand; acquiring information for specifying the image ordered by the customer, from the order sheet when the image is ordered by the customer who possesses the order sheet; specifying the ordered image on the basis of the information acquired; and performing a predetermined process which complies with the customer's order for the image, by using the image data of the ordered image as stored in the storage device. As in the sixth aspect, etc., therefore, when the customer orders the image in which he/she is photographed, he/she is permitted to be given a sufficient time for the check of the image, etc.

Further, As a thirteenth aspect, the predetermined sheet may well be constructed so as to include an electronic display medium which can electronically retain and visibly display a written image and which can rewrite the retained image, that the order sheet is produced in such a way that the image obtained by the photographing is written into the electronic display medium of the predetermined sheet, that the order sheet is collected when the image is ordered by the customer who possesses the order sheet, and that the predetermined sheet is reused by erasing the image written in the electronic display medium of the order sheet collected. Thus, the predetermined sheet can be repeatedly used for the order sheet.

### BRIEF DESCRIPTION OF THE DRAWINGS

FIG. 1 is a block diagram showing a schematic structure of an image ordering system according to an embodiment of the present invention;

FIGS. 2A and 2B are perspective views showing the external appearances of a digital still camera possessed by a cameraman;

FIG. 3 is a block diagram showing a schematic structure of an electric system of the digital still camera;

FIGS. 4 and 5 are flow charts showing the contents of image photographing processes, which are performed by the digital still camera;

FIG. 6 is a plan view showing an example of an order sheet;

FIGS. 7 and 8 are flow charts showing the contents of image ordering processes, which are performed by an order processing apparatus;

FIG. 9 is a flow chart showing the contents of an order receiving process which is performed by an order receiving terminal; and

FIG. 10 is an illustration for explaining the order sheet.

### DESCRIPTION OF THE PREFERRED EMBODIMENT

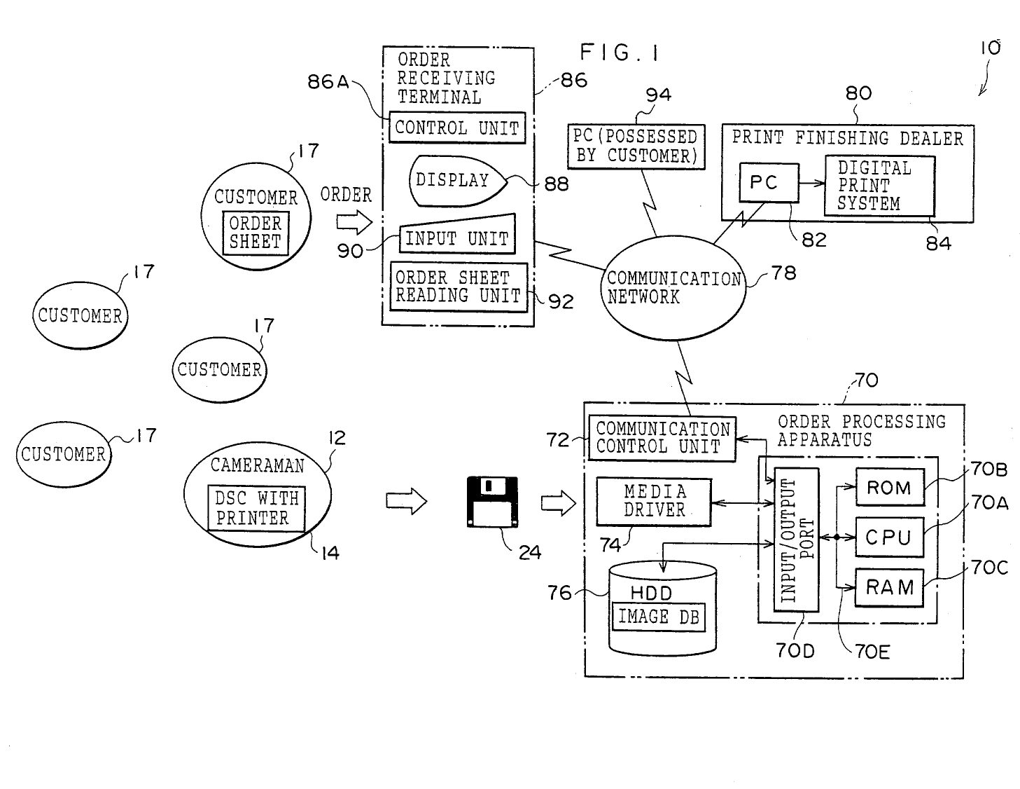

Now, an embodiment of the present invention will be described specifically with reference to the drawings. An image ordering system 10 according to embodiment is shown in FIG. 1. In the embodiment, at any photographing location, for example, a tourist site, a theme park, an event hall or a public garden, any person who happens to be there is photographed as a subject by a cameraman 12. The image ordering system 10 according to the embodiment is a system by which the persons (customers 17) photographed as the subjects in the above photographing can order photographed images (specifically, to give orders for creating photographic prints or for providing the image data of the photographed images). Although the constituents of appended claims and the contents of the embodiment will be explained in correspondence below, the constituents shall not be restricted to the stated contents.

The cameraman 12 possesses a digital still camera (hereinbelow, abbreviated to “DSC”) 14 having a internal printer, and he/she photographs images by employing the DSC 14. Incidentally, the DSC 14 corresponds to an image photographing apparatus according to the invention, but the image photographing apparatus is not restricted to such a DSC.

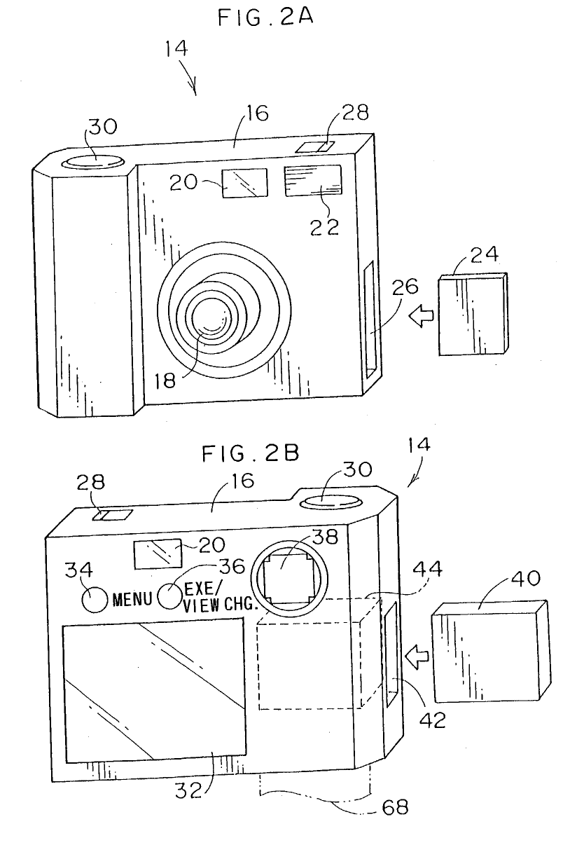

As shown in FIGS. 2A and 2B, the body 16 of the DSC 14 is substantially box-shaped and is formed with a protrusion (grip) for facilitating the grasp of the body 16, at the left side of the body 16 as viewed from the front thereof. As shown in FIG. 2A, a lens 18 is mounted at the front central part of the body 16. Mounted at the parts of the body 16 lying above the lens 18 are an optical finder 20 with which the user checks a photographing range etc. by the eye, and a strobo flash 22 which emits auxiliary light in case of photographing under a low illuminance, or the like. Moreover, a slot 26 for loading a recording medium 24 (for example, SMART MEDIA™, COMPACT FLASH™ or MEMORY STICK™) which records image data obtained by photographing (photographed image data) is provided in the right side surface of the body 16 as viewed from the front thereof.

On the top surface of the body 16, a power source switch 28 and a shutter button 30 are respectively disposed at the right and at the left (at a position corresponding to the grip) as viewed from the front. As shown in FIG. 2B, a display 32 which is constructed of an LCD or the like for reproducing and displaying photographed images is disposed at that part of the rear of the body 16 which lies below the optical finder 20. Further, a menu switch 34 and a display change switch 36 are respectively mounted over the display 32.

Further, at the rear of the body 16, a scroll switch 38 is disposed at the right upper part of the body 16 as viewed from the rear, and a slot 42 for loading a cartridge 40 in which a plurality of printing sheets are accommodated is provided in the right side surface of the body 16 as viewed from the rear. A printer unit 44 is disposed at that inner part of the body 16 which lies below the scroll switch 38. When instructed to print images on the printing sheet in a state where the cartridge 40 is loaded in the DSC 14, the printer unit 44 pulls out the printing sheet from the cartridge 40 and records the images. The sheet (order sheet 68 for which refer also to FIG. 1) on which the images have been recorded by the printer unit 44, is ejected from the bottom of the body 16.

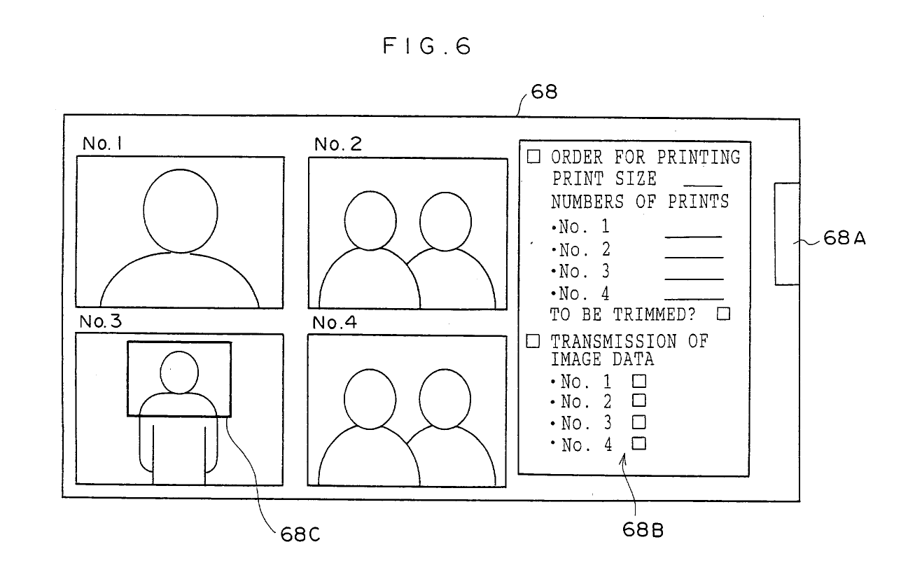

Incidentally, as also shown in FIG. 6, an IC chip 68A is mounted on the order sheet 68 (printing sheet) beforehand. The IC chip 68A is constructed of a nonvolatile semiconductor memory whose stored contents are rewritable, and the printer unit 44 has also the function of recording information in the IC chip 68A of the order sheet 68.

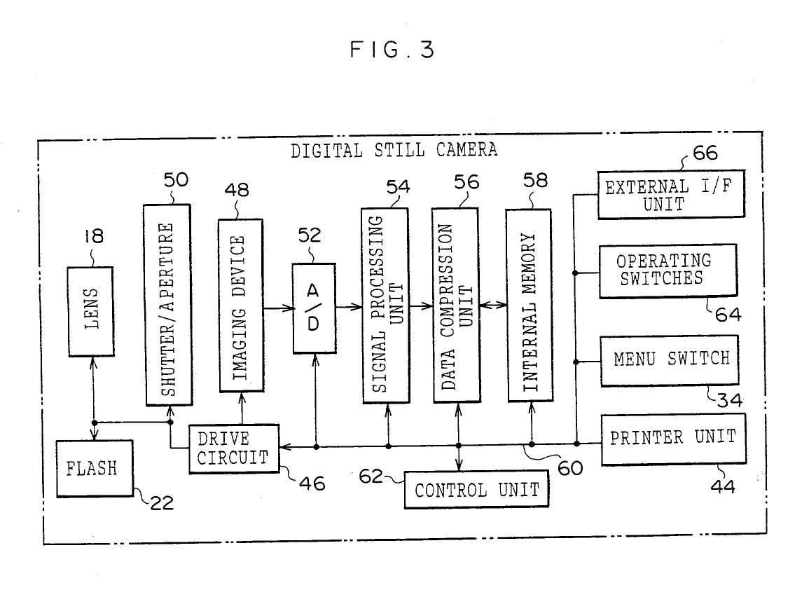

The construction of the electric system of the DSC 14 is shown in FIG. 3. The lens 18 is specifically a zoom lens (variable focal distance lens) including an autofocus (AF) mechanism, and the AF mechanism and zoom mechanism of the lens 18 are driven by a drive circuit 46. Incidentally, a fixed focal distance lens including only the AF mechanism may well be employed as the lens 18, instead of the zoom lens.

An imaging device 48 constructed of an area CCD sensor or the like is arranged at that position inside the body 16 which corresponds to the focal point of the lens 18, and light reflected from a subject and entering the lens 18 is focused on the photosensitive face of the imaging device 48. The imaging device 48 is driven at a timing synchronized with a timing signal which is generated by the internal timing generation circuit (not shown in figure) of the drive circuit 46, and it outputs an image signal (a signal expressing the amounts of received lights on a large number of individual photoelectric cells which are arrayed in a matrix shape on the photosensitive face).

A shutter/aperture 50 is arranged between the lens 18 and the imaging device 48. The shutter and aperture are driven by the drive circuit 46. The shutter serves to prevent smear from appearing due to the incidence of light on the photosensitive face of the imaging device 48 when the image signal is outputted from the imaging device 48, and the shutter can be omitted in some constructions of imaging devices 48. Further, the aperture may be constructed of a single aperture which can continuously alter a stopping quantity, or it may well be constructed so as to change a plurality of apertures having different stopping quantities. The drive circuit 46 is also connected to the flash 22. The flash 22 is fired by the drive circuit 46 in a case where the low illuminance has been detected or where the user has given the instruction of firing.

An A/D converter 52, a signal processing unit 54, a data compression unit 56 and a internal memory 58 are connected to the signal output end of the imaging device 48 in the order mentioned. The image signal outputted from the imaging device 48 is converted by the A/D converter 52 into digital image data, which is inputted to the signal processing unit 54 and is subjected to various processes such as color correction, gamma correction and Y/C transformation. The image data outputted from the signal processing unit 54 is compressed and translated into an image file of predetermined format (for example, JPEG format) by the data compression unit 56, and the image file is temporarily stored in the internal memory 58.

The drive circuit 46, A/D converter 52, signal processing unit 54, data compression unit 56 and internal memory 58 are connected to a bus 60. A control unit 62, which includes a CPU, a ROM (in which a program for performing an image photographing process to be explained later is stored beforehand) and a RAM, and the menu switch 34 are connected to the bus 60. Further, switches (expressed as “operating switches 64”, in FIG. 3) which include the power source switch 28, the display change switch 36, the scroll switch 38, and a shutter switch adapted to be turned ON/OFF by operating the shutter button 30 are connected to the bus 60. Also connected to the bus 60 are the printer unit 44 mentioned before, and an external I/F unit 66 through which information is written into and read out of the recording medium 24 loaded in the slot 26.

In FIG. 3, the various components except the printer unit 44 correspond to an image photographing apparatus recited in claim 1, and the control unit 62 functions as an order sheet producing component recited in claim 1, in cooperation with the printer unit 44.

Next, the order processing apparatus 70 of the image ordering system 10 as shown in FIG. 1 will be described. The order processing apparatus 70 comprises a computer such as workstation, which is constructed such that a CPU 70A, a ROM 70B, a RAM 70C and an input/output port 70D are interconnected through a bus 70E, and a communication control unit (for example, modem or router) 72, a media driver 74 and a hard disk drive (HDD) 76 are respectively connected to the input/output port 70D.

An image ordering program is installed in the HDD 76 of the order processing apparatus 70 in advance such that an image ordering process according to the invention (to be described specifically later) is executed by the CPU 70A of the order processing apparatus 70. The CPU 70A executes the image ordering program, whereby the computer constructing the order processing apparatus 70 functions as the order processing apparatus according to the invention. The order processing apparatus, however, is not restricted to the computer constructing the order processing apparatus 70.

Each time the cameraman 12 takes a photograph, the DSC 14 possessed by him/her records photographed image data and other information in the recording medium 24. The media driver 74 reads out the information of the photographed image data etc. from the recording medium 24 which has been carried in by the cameraman 12. An image database (image DB) for storing image data etc. therein is disposed in the HDD 76, and the information read out of the recording medium 24 by the media driver 74 is stored (stored) in the image DB of the HDD 76. In this manner, the HDD 76 corresponds to a storage device recited in claim 11.

Further, the communication control unit 72 of the order processing apparatus 70 is connected to a communication network 78. The communication network 78 is constructed including at least one of a public telephone network, a dedicated communication network of high speed and high capacity, and a computer network such as the Internet. Also connected to the communication network 78 are computers (PC) 82 which are respectively possessed by print finishing dealers 80 existent in large numbers all over the country, a plurality of order receiving terminals 86, and a computers (PC) 94 which is possessed by the customer 17 of the image ordering system 10.

The print finishing dealer 80 possesses a digital print system 84 configured of such equipment as a film scanner which reads an image recorded on a photographic film, and a digital printer which performs a print finishing process for recording an image expressed by image data, on sensitized paper or the like recording material. The digital print system 84 is connected to the PC 82, and it can also perform the print finishing process by employing image data which the PC 82 has received through the communication network 78.

Further, the order receiving terminal 86 is a terminal for receiving an order given by the customer 17, and it is installed in any desired place which may be near a place where the cameraman 12 is taking photographs, or which may well be a place having no relation with the photographing place (for example, the counter of a convenience store or a photo shop) The order receiving terminal 86 comprises a control unit 86A which includes a CPU, a ROM (in which a program for performing an order receiving process to be described later is stored beforehand), a RAM, etc., a display 88 which includes a CRT, an LCD or the like and which is capable of displaying an image etc., an input unit 90 which includes a keyboard or the like for allowing the customer 17 to input any desired information, and an order sheet reading unit 92. This order receiving terminal 86 has also the function of communicating with the order processing apparatus 70 through the communication network 78.

Further, the order sheet reading unit 92 is provided with an insertion slot (not shown) for inserting the order sheet 68, and it has an internal image scanner not shown. The order sheet reading unit 92 reads out information from the IC chip 68A of the order sheet 68 inserted through the insertion slot, and also functions to read the loaded order sheet 68 by the image scanner.

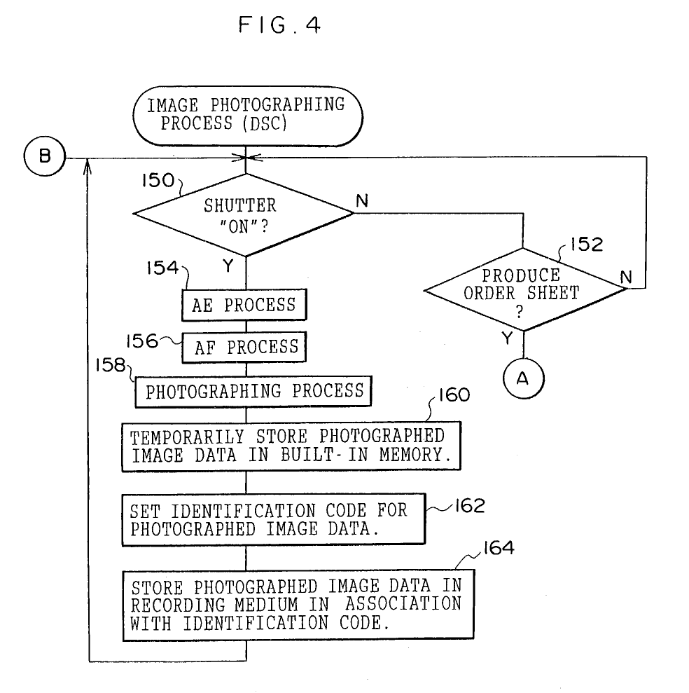

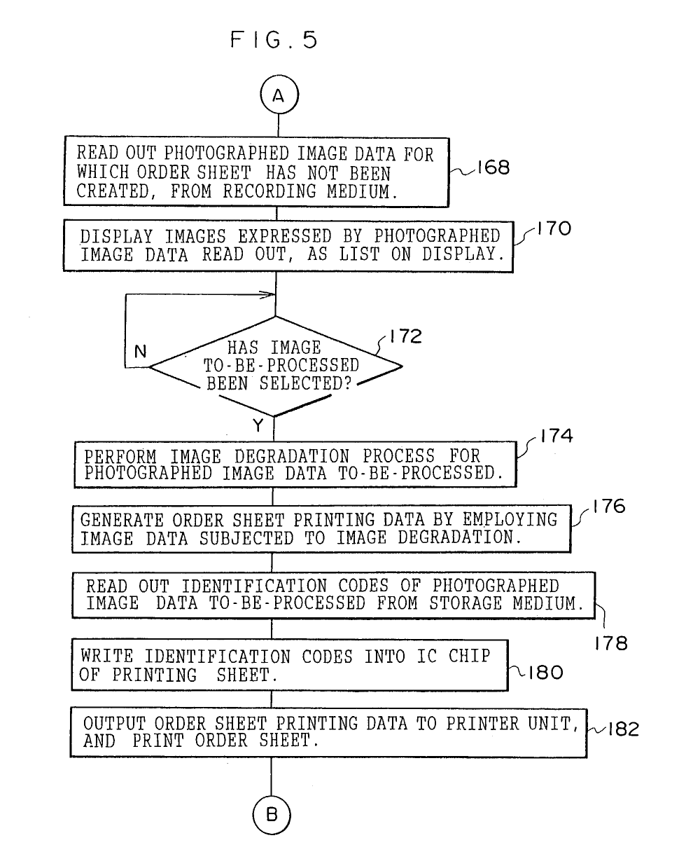

Next, the operation of the embodiments will be described. In the embodiments, the cameraman 12 waits for the arrival of a person who is to become a subject, while staying at or loitering near a predetermined position in any photographing place mentioned before. When the person has arrived, the cameraman 12 photographs the person having arrived, by the use of the DSC 14 possessed. The cameraman 12 repeats such actions. The image photographing process which is performed by the control unit 62 of the DSC 14 during the application of the power source of the DSC 14 will be described with reference to flow charts of FIGS. 4 and 5.

At a step 150, the control unit 62 decides whether or not the shutter button 30 has been pressed by the cameraman 12. In a case where the decision is a negative, the routine shifts to step 152, at which the control unit 62 decides whether or not the producing of the order sheet 68 has been instructed through the manipulation of the operating switch 64 by the cameraman 12. In a case where this decision has also been negated, the routine returns to the step 150. The steps 150 and 152 are repeated until one of the decisions is affirmed.

When the cameraman 12 checks a subject to-be-photographed by looking through the optical finder 20 of the DSC 14 and then presses the shutter button 30, the shutter switch is turned ON. Then, the decision of the step 150 is affirmed, and the routine shifts to a step 154. An AE processing is performed which: obtains from the imaging device the image data (image signal), which was temporally stored in the internal memory 58 via the A/D converter 52, the signal processing unit 54, and the data compression unit 56; automatically determines exposure based on this image data; determines a shutter speed (a charge storage time of the imaging device 48) and an amount of stop in the aperture; and drives the aperture and controls the operating timing of the electric shutter of the imaging device 48 via a driving circuit 46.

At a step 156, a known AF process proceeds in which a focused position (a lens position in a focused state) is searched for, whereupon the stepping motor of the AF mechanism of the lens 18 is driven so as to establish the focused state. Moreover, at a step 158, a photographing process proceeds in which the subject is imaged by the imaging device 48 in the focused position. At the next step 160, image data obtained via the A/D converter 52, signal processing unit 54 and data compression unit 56 is temporarily stored in the internal memory 58 as photographed image data.

At the next step 162, an identification code for identifying each individual photographed image data is set for the photographed image data temporarily stored in the internal memory 58. Further, at a step 164, the photographed image data temporarily stored is written into the recording medium 24 in association with the identification code set at the step 162, whereupon the routine returns to the step 150. The above processing steps are repeated by the respective photographing operations of the cameraman 12, whereby the photographed image data obtained by the photographing operations are successively stored in the recording medium 24 in association with the identification codes differing from one another.

Further, each time the cameraman 12 finishes taking either one photograph or a plurality of photographs whose subject (subjects) is (are), for example, an identical person or a plurality of persons forming a single group, the cameraman 12 manipulates the operating switch 64 and instructs the control unit 62 to produce the order sheet 68 which is to be delivered to the customer 17 who is the subject. Thus, the decision of the step 152 is affirmed and is followed by a step 168.

The processing of the step 168, et seq. corresponds to an order sheet producing component recited in claim 1 (specifically, an order sheet producing component recited in claim 6 or claim 7). At the step 168, those of the photographed image data stored in the recording medium 24 for which the order sheets 68 have not been produced are all read out. Further, at a step 170, the control unit 62 causes the display 32 to indicate a list of images expressed by the photographed image data read out at the step 168, and to indicate a message for requesting the cameraman 12 to select the image which is to be recorded on the order sheet 68 to-be-produced.

At the next step 172, the control unit 62 decides whether or not the image to be processed (the image to be recorded on the order sheet 68) has been selected by the cameraman 12, and it waits until the decision is affirmed. When the cameraman 12 having referred to the message indicated on the display 32 at the step 168 selects, for example, all the images in which the customer 17 to have the order sheet 68 delivered is photographed as subjects, the decision at the step 172 is affirmed. Then, the routine shifts to a step 174, at which the photographed image data of the images selected by the cameraman 12 are subjected to an image degradation process for lowering a resolution and for decreasing the number of gradations.

At the next step 176, the control unit 62 generates printing data for order sheet creating by employing the image data degraded by the image degradation process of the step 174, which printing data for order sheet creating is used by the printer 44 to record the images and characters for order sheet 68 on the printing sheet as shown in FIG. 6. The order sheet 68 exemplified in FIG. 6 is formed such that the plurality of orderable images are recorded in the shape of a matrix, while a column 68B is provided which bears the characters for assisting the entries of order contents by the customer 17.

In the example of FIG. 6, the type of the order (either an order for printing or the transmission of image data) can be designated as the order content. Further, in a case where the type of the order is the order for printing, a print size as well as the numbers of prints and the presence or absence of trimming can be designated, and in a case where the type of the order is the image data transmission, the images to be transmitted can be designated. Incidentally, the column 68B may well be provided at the back surface of the order sheet 68. Also, the installed locations of the order receiving terminals 86, the advertisement of a specified photo shop where the order receiving terminal 86 is installed, etc. may well be recorded on the back surface of the order sheet 68.

At a step 178, the identification codes stored in association with the photographed image data to-be-processed are respectively read out of the recording medium 24. At the next step 180, the single printing sheet is taken out of the cartridge 40, whereupon the control unit 62 controls the printer unit 44 so that the identification codes read out at the step 178 may be written into the IC chip 68A of the printing sheet taken out.

Further, at a step 182, the control unit 62 outputs the order sheet printing data generated at the step 176, to the printer unit 44, and it controls the printer unit 44 so that the images and characters expressed by the order sheet printing data may be recorded on the printing sheet taken out at the step 180 (the printing sheet in which the identification codes have been written into the IC chip 68A). Thereafter, the routine returns to the step 150. Thus, the order sheet 68 as shown in FIG. 6 is produced and is ejected out of the body 16 of the DSC 14.

When the produced order sheet 68 has been ejected outside the body 16 of the DSC 14, the cameraman 12 delivers the produced order sheet 68 to the customer 17. Thus, the customer 17 can check the photographed images, etc. by referring to the delivered order sheet 68. Moreover, although detailed description shall be omitted, the delivery of the order sheet 68 to the customer 17 can make ordering the images recorded on the order sheet 68 easy for him/her, owing to the order sheet 68 even when a certain period has lapsed since the photographing. Therefore, the customer 17 need not order the images immediately after the photographing, and he/she can order the images after sufficiently ascertaining the images printed on the order sheet 68 and reaching the conclusion of ordering the images.

Incidentally, the images to be recorded on the order sheet 68 are respectively recorded using the image data degraded by the image degradation process. Therefore, the producing of the order sheet 68 (the recording of the images) by the printer unit 44 can be completed in a short time, and the customer 17 waiting unnecessarily long for the delivery of the order sheet 68 can be avoided.

Meanwhile, the cameraman 12 sends the recording medium 24 to an administration center where the order processing apparatus 70 is installed, at such a timing that he/she has photographed a fixed number of images or has ended daily photographing. An operator in the administration center sets the recording medium 24 sent from the cameraman 12, on the media driver 74 of the order processing apparatus 70.

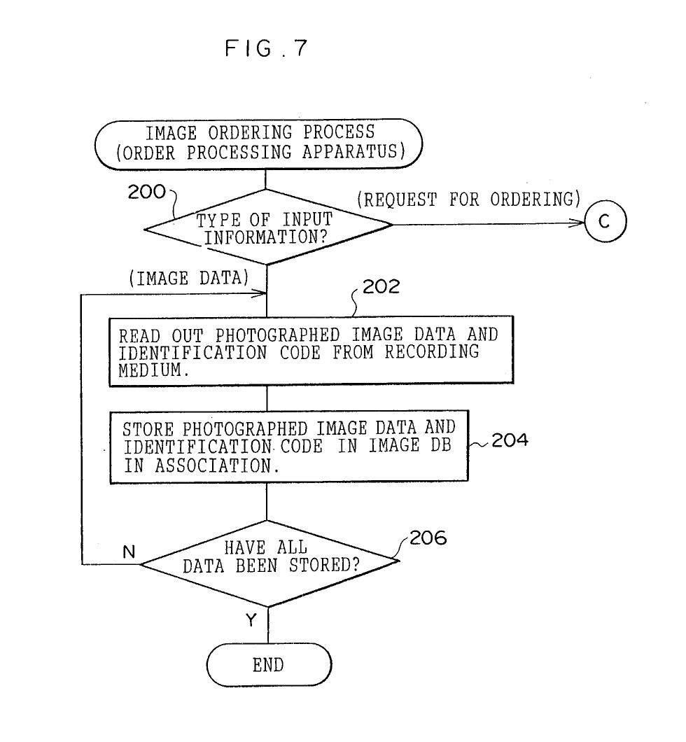

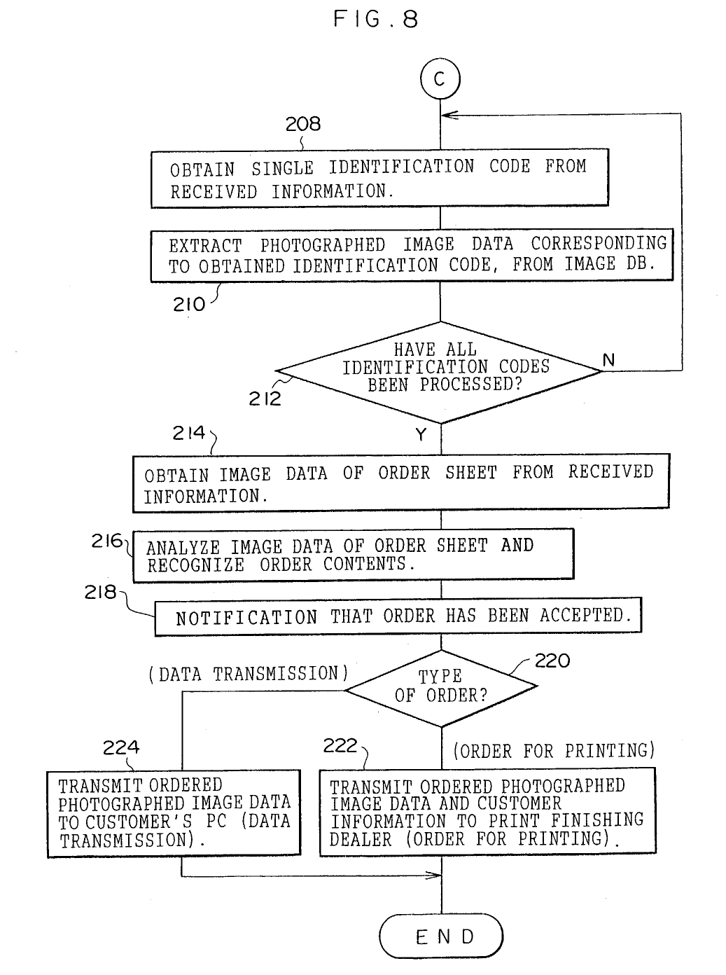

In the order processing apparatus 70, the image ordering process shown in FIGS. 7 and 8 is started when the recording medium 24 has been set on the media driver 74 or when any information has been received from the order receiving terminal 86. In the image ordering process, the type of input information is decided at a step 200. In a case where the process has been started by the setting of the recording medium 24 on the media driver 74, the input information is judged as the photographed image data, whereupon the routine shifts to a step 202.

At the step 202, the single photographed image data, and the identification code stored in association with the photographed image data are read out of the recording medium 24. At the next step 204, the photographed image data and the identification code read out at the step 202 are stored in association in the image DB provided in the HDD 76. At the next step 206, whether or not all the photographed image data recorded in the recording medium 24 have been stored in the image DB is decided.

Subject to the negation of the decision, the routine returns to the step 202, and the steps 202-206 are repeated until the decision at the step 206 is affirmed. When the decision at the step 206 is affirmed meantime, the image ordering process is ended. The above processing steps are performed each time the recording medium 24 is received from the cameraman 12, whereby the photographed image data and the identification codes are respectively recorded in the image DB for all the images photographed by the cameraman 12.

Next, the image ordering will be described. After the customer 17 to whom the order sheet 68 was delivered at the photographing ascertains and appreciates sufficiently the images recorded on the order sheet 68, he/she writes the order contents into the column 68B of the order sheet 68 by handwriting for any images desired to be ordered. Further, in a case where the type of the order is the order for printing and where the producing of a photographic print obtained after trimming the photographed image is desired, the customer 17 enters a frame expressive of a trimming range by handwriting as shown at a sign “68C” in FIG. 6 by way of example.

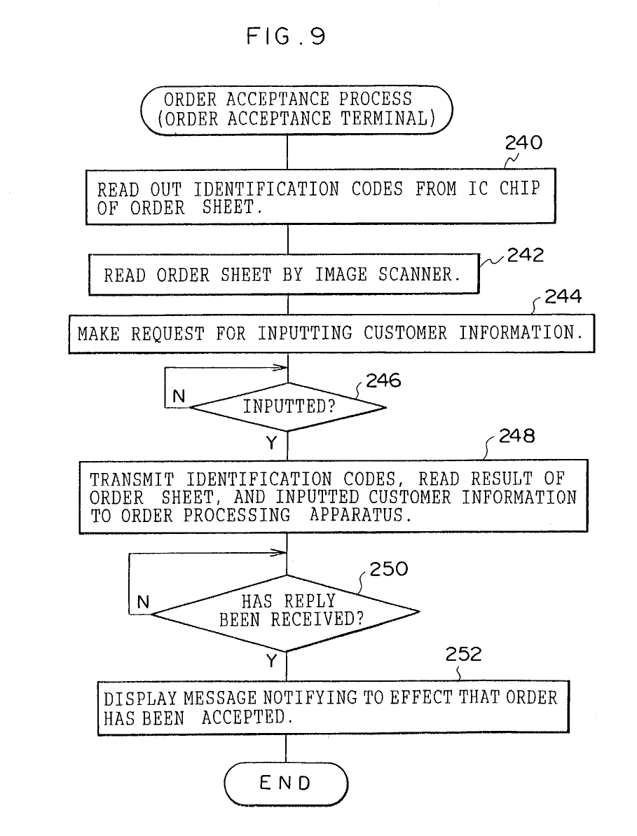

Further, when the customer 17 has written the order contents into the order sheet 68, he/she goes to the place where the order receiving terminal 86 is installed, and he/she inserts the order sheet 68 through a slot provided in the order sheet reading unit 92 of the order receiving terminal 86. Thus, the order receiving process shown in FIG. 9 is performed by the control unit 86A of the order receiving terminal 86.

More specifically, at a step 240, the identification codes of the images recorded on the order sheet 68 are respectively read out of the IC chip 68A of the order sheet 68 inserted through the slot, by the order sheet reading unit 92. At the next step 242, the inserted order sheet 68 is read by the image scanner of the order sheet reading unit 92. At a step 244, a message for requesting the customer 17 to input customer information is displayed on the display 88, whereby the customer 17 is requested to input the customer information. At a step 246, whether or not the customer information has been inputted is decided, and the affirmation of the decision is waited.

When requested to input the customer information, the customer 17 inputs the customer information such as a name, an address and a telephone number to make contact, through the input unit 90. Further, in a case where the type of the order is the “transmission of image data”, the customer 17 simultaneously designates information (for example, his/her e-mail address) for specifying the transmission destination of the image data to-be-ordered. Thus, the decision at the step 246 is affirmed, whereupon the routine shifts to a step 248. It is also possible to assign a customer ID to the customer 17 whose order has been received, and to store the customer information inputted by the customer 17, in association with the customer ID, whereby in the next order, et seq., the customer 17 inputs only the customer ID so as to read out the customer information corresponding to the inputted customer ID. Further, it is also possible to write the customer information inputted by the customer 17, onto a customer card or the like, and to deliver the customer card or the like to the customer 17, whereby in the next order, et seq., the customer information is read out of the customer card or the like possessed by the customer 17.

At the next step 248, the identification codes read out of the IC chip 68A of the order sheet 68, the image data of the order sheet 68 as obtained by reading this order sheet by means of the image scanner, and the customer information inputted by the customer 17 are transmitted as order request information to the order processing apparatus 70 through the communication network 78. At the next step 250, whether or not a reply has been received from the order processing apparatus 70 is decided, and the affirmation of the decision is awaited.

When the order request information transmitted from the order receiving terminal 86 is received by the order processing apparatus 70, the image ordering process (FIGS. 7 and 8) is started in the order processing apparatus 70, and the routine shifts from the foregoing step 200 to a step 208. At the step 208, the identification information of the single image is obtained from the received order request information. At the next step 210, the image DB of the HDD 76 is searched with the obtained identification information as a key, whereby the single photographed image data corresponding to the taken-out identification information is extracted from the image DB. In this manner, the photographed image data of the image recorded on the order sheet 68 can be easily acquired by employing the identification code as the key.

At the next step 212, whether or not the above processing has been done for all the identification codes contained in the received order request information is decided. If the decision is negative, the routine returns to the step 208, and the steps 208-212 are repeated until the decision at the step 212 is affirmed. Thus, the photographed image data of all the images recorded on the order sheet 68 can be acquired.

When the decision at the step 212 is affirmative, the routine shifts to a step 214, at which the image data of the order sheet 68 is obtained from the received order request information. Further, at a step 216, the obtained image data of the order sheet 68 is analyzed so as to recognize the order contents (the type of the order, etc.) from the customer 17.

The recognition of the order contents can be done, for example, in such a way that image data obtained by reading the column 68B of the order sheet 68 when the column 68B is blank is prepared in advance, that the image data of an area corresponding to the column 68B is extracted from the image data obtained from the order request information, that the extracted image data is compared and collated with the image data prepared beforehand, thereby to extract marks and characters which the customer 17 has entered by handwriting, and that the positions of the extracted marks are judged, while the extracted characters are recognized.

Further, regarding the trimming frame 68C which the customer 17 has entered by handwriting, a line corresponding to the trimming frame 68C is extracted, for example, in such a way that the image data of areas corresponding to the individual images are extracted from the image data obtained from the order request information, and that the extracted image data are compared and collated with the photographed image data extracted from image DB at the foregoing step 210, and the trimming range can be judged from the position of the extracted line.

Incidentally, the above steps 208-216 correspond to an acquisition component recited in claim 11 (specifically, in claims 13 and 16), in cooperation with the order receiving terminal 86 which reads out the identification codes from the IC chip 68A of the order sheet 68 and reads the order sheet 68 by the image scanner.

When the identification of the order contents from the customer 17 is complete, in the next step 218, information, which notifies the order receiving terminal 86 that the order has been received, is transmitted to the order receiving terminal 86, which originally sent the order request information. When the information has been received by the order receiving terminal 86, the decision at the step 250 of the order receiving process (FIG. 9) proceeding in the order receiving terminal 86 is affirmed, followed by a step 252. At the step 252, a message notifying to the effect that the order has been received is indicated on the display 88 of the order receiving terminal 86. Thus, the customer 17 can recognize that the order has been received.

Incidentally, the order receiving terminal 86 may well be furnished with the function of creating copies of the order sheet 68 (sheets on which the same image is recorded) on the basis of the order sheet 68 possessed by the customer. Thus, such an application is permitted that the customer to whom the order sheet 68 has been delivered from the cameraman 12 obtains the copies of the order sheet 68 by utilizing the order receiving terminal 86, that he/she distributes the obtained copies to his/her acquaintances, and that he/she gives an order for printing after totaling orders for printing as desired by the customer himself/herself and his/her acquaintances (for example, totaling the numbers of the prints of the individual images), another day.

On the other hand, in the image ordering process which is proceeding in the order processing apparatus 70, at the next step 220, whether the type of the order given by the customer 17 is the order for printing or the transmission of the image data is decided on the basis of the order contents recognized at the step 216.

In a case where the type of the order is the order for printing, the routine shifts from the step 220 to a step 222. Here at the step 222, a print finishing dealer 80 which is the most suitable for the current order for printing is selected from among the large number of print finishing dealers 80 on the basis of the address etc. of the customer 17 who can be specified by the customer information contained in the order request information. Thereafter, information expressing the order contents (the print sizes, the numbers of the prints of the individual images to-be-ordered, and the presence or absence of the trimming, as well as the trimming range) recognized at the step 216, the photographed image data of the ordered individual images, the customer information of the customer 17, etc. are transmitted to the PC 82 of the selected print finishing dealer 80. Thus, the customer's order for printing is given to the print finishing dealer 80, and the image ordering process is ended.

In a case where the order receiving terminal 86 being the transmission source of the order request information is installed at the counter of a specified photo shop, a specified print finishing dealer 80 related to the specified photo shop should desirably be selected in the above stage of selecting the print finishing dealer 80.

The print finishing dealer 80 which has received the above information by the PC 82 through the communication network 78 produces photographic prints with the print sizes and to the numbers of the prints as conform to the information expressing the received order contents (in the presence of the trimming, it produces a photographic print trimmed in the designated trimming range), by employing the received photographed image data, and it sends the produced photographic prints to the address of the customer 17. Thus, the customer 17 can receive the photographic prints of the images selected and ordered, under the conditions (sizes and numbers) conforming to the designated order contents.

Further, in a case where the order given by the customer 17 is the “transmission of image data”, the routine shifts from the step 220 to a step 224, at which the photographed image data of the images selected and ordered by the customer 17 are transmitted to the transmission destination designated by the customer 17, whereupon the image ordering process is ended. Thus, the customer 17 can receive the photographed image data of the images selected and ordered, through the PC 94 or a portable telephone set or the like possessed by the customer 17. The above steps 220-224 correspond to the process performed by a processing component recited in claim 11 (specifically, a processing component recited in claim 17).

Incidentally, the ordered photographed image data may well be delivered to the customer 17 in such a way that, instead of the transmission of the photographed image data as stated above, the photographed image data are recorded in a predetermined recording medium (for example, a floppy disk, a CD-R or an MO), whereupon the recording medium is sent to the customer 17. Further, in transmitting or delivering the photographed image data to the customer 17, a predetermined image process (for example, scale-up/down, trimming, or an image process for enhancing an image quality) may well be performed.

Further, the case where the photographed image data obtained by the photographing with the DSC 14 are stored (stored) in the HDD 76 (image DB) of the order processing apparatus 70 through the recording medium 24 has been described above. However, the invention is not restricted to this case, but the corresponding photographed image data may well be transmitted from the DSC 14 to the order processing apparatus 70 by radio at such a timing as each time a photograph is taken with the DSC 14 or each time an image is recorded on the order sheet 68.

Incidentally, the case where the cameraman 12 takes photographs has been described above. Needless to say, however, the invention is not restricted to this case, but photographs may well be automatically taken so as to produce the order sheets 68 and to deliver them to the customers 17. More specifically, a photographing component and a printer (the image photographing apparatus according to the present invention) are installed on each seat of a vehicle arranged in, for example, a theme park, the photographs are automatically taken at predetermined timings by the photographing component, and photographed image data obtained by the automatic photographing are transmitted to the order processing apparatus (the data transmission may be done by either a wired or a wireless system). Thus, the photographed image data are stored in the order processing apparatus in preparation for an order for images as is given by a customer. Also, when the customer having been in his/her seat in the vehicle gets off the vehicle, the order sheet 68 is produced and outputted (delivered to the customer) by the printer on the basis of the photographed image data.

Further, as a modification to the above aspect, the numbers and installed places of photographing components and printers may well be different. For example, the installed position and photographing range of one photographing component are set so as to be capable of photographing a plurality of seats (customers in their seats) at one time, and photographed image data obtained by the automatic photographing based on the pertinent photographing component is transmitted to the plurality of printers respectively installed on the seats located within the photographing range of the photographing component, so as to respectively produce and output order sheets on which the same image is recorded. Further, the installed positions and photographing ranges of the individual photographing components are set so that a specified subject may be photographed at a plurality of spots or in a plurality of directions by the plurality of photographing components (for example, in order to photograph the same person in time series in a plurality of places along the traveling route of the vehicle, or to photograph the same person in the plurality of directions at an identical timing). In this case, a plurality of images photographed by the plurality of photographing components are recorded as index images on an order sheet.

Further, the example in which the customer 17 enters the order contents into the column 68B of the order sheet 68 has been described above. However, the invention is not restricted to this example, but the order contents may well be designated and inputted, for example, in such a way that an input unit of touch panel type is installed in the order receiving terminal 86, and that the customer 17 manipulates an electronic pen or the like in a state where the photographed image is indicated on a display screen.

Further, the aspect in which the IC chip 68A is mounted on the order sheet 68 and in which the identification codes for identifying the individual photographed images are written into the IC chip 68A has been exemplified in the above. However, the invention is not restricted to this aspect, but a magnetic recording medium such as magnetic tape may well be affixed to the order sheet 68 instead of the IC chip 68A, so as to magnetically record the identification codes or the like information on the magnetic recording medium. Further, the identification codes or the like information may well be recorded as bar codes or the likes on the order sheet 68.

For example, scaled-down image data obtained by lowering the resolution of the photographed image data are mentioned as the information other than the identification codes, well suited to be recorded in or on the IC chip or the magnetic recording medium. When the scaled-down image data are recorded beforehand, the customer is permitted to check the photographed images by displaying the photographed images with the scaled-down image data or displaying the photographed images on the customer's PC with the scaled-down image data in a case, for example, where he/she orders the images through the order receiving terminal 86. Further, the photographed image data itself may well be recorded on the order sheet, instead of the scaled-down image data. In this case, recording the identification code on the order sheet or saving the photographed image data in the order processing apparatus is omitted. In this manner, the photographed image data is also included in the identification information recited in claim 1. In the case where the photographed image data is recorded on the order sheet, it may well be recorded on the order sheet after subjecting it to predetermined encoding so that only predetermined order receiving terminals 86 or affiliated print finishing dealers 80 can display images or produce photographic prints.

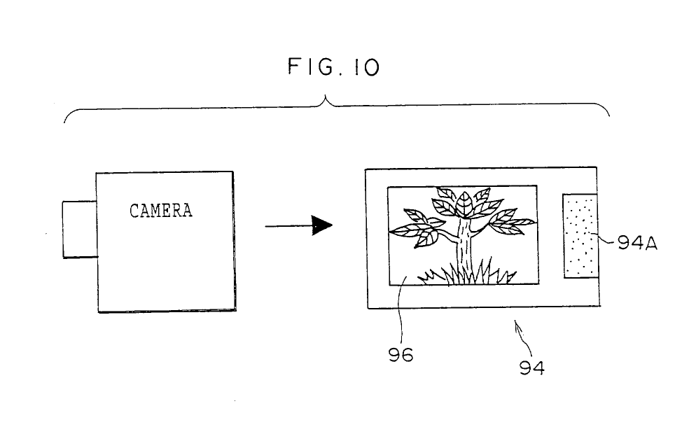

Further, a sheet for creating the order sheet may well be provided with an electronic display medium such as electronic paper, which electronically retains and visibly displays a written image and in which the retained image is rewritable. An order sheet 94 shown in FIG. 10 is produced in such a way that an image and an identification code are respectively written into an electronic display medium 96 and into an IC chip 94A by a writing unit (non-shown, and corresponding to an order sheet producing component recited in claim 9) disposed in a camera (for example, DSC). The electronic display medium 96 is adapted to rewrite the retained image (display image). Therefore, the sheet can be repeatedly utilized for the producing of an order sheet by reloading it into the camera after the order sheet 94 is collected upon the receiving of the order for the image as given by the customer, whereupon the image written on the electronic display medium 96 and information, such as the identification code, written in the IC chip 94A are erased. The above aspect corresponds to claim 21, but claim 21 is not narrowly restricted to the above aspect. Further, the order sheet may well be formed as a so-called “sticker” in which an image part is usable as an adhesive sticker.

In addition, exemplified above has been the aspect where the identification codes assigned to the individual photographed images are recorded on the order sheet 68 beforehand, and where the image DB is searched with the key being the identification code recorded on the order sheet 68, thereby to extract the photographed image data of the ordered image. However, the invention is not restricted to this aspect, but the photographed image data of the ordered image may well be extracted in such a way that image data corresponding to each individual image is extracted from the image data of the order sheet 68 as obtained by reading this order sheet 68 by means of the image scanner, without recording the identification codes or the like information on the order sheet 68, and that the extracted image data is compared and collated with individual photographed image data stored in the image DB of the HDD 76. Such an aspect corresponds to claim 15.

In the above aspect, the process for specifying the photographed image data of the ordered image becomes complicated, but preparing the special DSC 14 which is endowed with the function of recording the identification codes or the like information on the order sheet 68 is unnecessary. Moreover, in the above aspect, the order can be received as long as the image data of the order sheet 68 exists. Therefore, the customer 17 can order the image recorded on the order sheet 68, in such a way that he/she enters also information corresponding to the customer information stated before, into the order sheet 68 by handwriting, and thereafter transmits the order sheet 68 by a facsimile equipment.

Further, in a case where the customer 17 possesses an image scanner connectable to the PC 94, he/she can also order an image in such a way that ordering software or the like is downloaded and installed in the PC 94 via the communication network 78 beforehand, and that the image data of the order sheet 68 as obtained by reading this order sheet by means of the image scanner is transmitted to the order processing apparatus 70 by utilizing the ordering software.

Further, the “image” in the invention is not restricted to a still image, but a moving image may well be recorded instead of the still image by employing a digital video camera instead of the digital still camera 14 as the image photographing apparatus according to the invention. In this case, one or more still images extracted from the photographed moving image may be recorded on the order sheet. Moreover, audio may well be recorded at the photographing, whereby audio data obtained by the recording is turned into characters by speech recognition, and the characters are recorded on the order sheet or are recorded on a photographic print produced on the basis of a customer's order for printing, in combination with an image. Further, the “image data transmission” has been ordered, the above audio data may well be transmitted together with the photographed image data (data of the still image/moving image).

In addition, the case where the customer's order for the image is received by the order processing apparatus 70 has been described above. However, the invention is not restricted to this case, but each individual photo shop or print finishing dealer 80 may well acquire photographed image data by receiving an order given by the customer and then transmitting to the order processing apparatus 70 the identification code recorded on the order sheet 68 and the image data of the order sheet 68 as obtained by reading this order sheet 68, thereby requesting transmission of the corresponding photographed image data.

In the above, there has been described the example in which an identification code is set for photographed image data obtained by photographing, and the set identification code is associated with the photographed image data and is also written into the IC chip 68A of a printing sheet (order sheet 68) bearing an image expressed by the photographed image data. However, the present invention is not restricted to the example, but it is also allowed to write an identification code in the IC chip 68A of the printing sheet (order sheet 68) beforehand, to read out the identification code from the IC chip 68A when an image is recorded on the printing sheet, and to store the read-out identification code in association with photographed image data corresponding to the recorded image. Such processing corresponds to the information adding component recited in claim 1.

Further, although the example in the case of photographing a person as a subject has been described above, the present invention is, of course, applicable also to a case of photographing any other than the person (for example, a scene) as a subject.

What is claimed is:

1. An image photographing apparatus comprising:
a photographing component; and
an order sheet producing component for producing an order sheet, which is usable by the customer to order a photographed image, by printing an image, which was obtained by being photographed by the photographing component, on a predetermined sheet;
wherein, the order sheet producing component
records, on the predetermined sheet, identification information for identifying the photographic image, or
further comprises an information adding component for reading out identification information stored in advance on the predetermined sheet and adding the identification information to image data of the image, which was obtained by the photographing with the photographing component.

2. The image photographing apparatus of claim 1, wherein the photographing component obtains a still image or a moving image by photographing a subject.

3. The image photographing apparatus of claim 1, wherein the order sheet producing component records a single photographed image or a plurality of photographed images, and identification information for identifying the photographed image or images on the predetermined sheet.

4. The image photographing apparatus of claim 1, wherein image data of the image obtained by the photographing based on the photographing component, after being recorded in a recording medium, is one of
read out of the recording medium by an order processing apparatus and
transmitted to the order processing apparatus,
to be stored in a storage device of the order processing apparatus.

5. The image photographing apparatus of claim 4, further comprising a recording component for recording the image data on the recording medium.

6. The image photographing apparatus of claim 1, wherein
identification information is recorded by the order sheet producing component or recorded in advance on an IC chip or a magnetic medium disposed on the order sheet in advance; or
code expressing the identification information is recorded by the order sheet producing component or recorded in advance.

7. The image photographing apparatus of claim 1, wherein the order sheet producing component degrades an image quality of the image data obtained by the photographing with the photographing component, and prints the photographed image on the predetermined sheet by using the image data, which was subjected to the image quality degradation.

8. The image photographing apparatus of claim 7, wherein the order sheet producing component degrades the image quality by at least one of degrading resolution, decreasing a number of gradations, reducing a number of colors, simplifying to a line drawing, and simplifying to a cartoon-like image.

9. The image photographing apparatus of claim 1, wherein:
the predetermined sheet includes an electronic display medium, which can electronically retain and visibly display the written image and can rewrite the retained image; and
the order sheet producing component writes the image, which was obtained by the photographing with the photographing component, into the electronic display medium of the predetermined sheet.

10. An order sheet for having the image, which was obtained by photographing with the photographing component of the image photographing apparatus of claim 1, recorded thereon by the image sheet producing component of the image photographing apparatus, and for having one of
a) identification information for identifying the photographed image recorded thereon by the order sheet producing component, and
b) identification information for being added to the image data of the photographed image, which identification information is recorded in advance, read out therefrom by the information adding component.

11. An order processing apparatus comprising:
a storage device for storing image data obtained by photographing any object desired as a subject with an image photographing apparatus;
an acquisition component for acquiring information for specifying an image ordered by a customer, from an order sheet, which was produced by printing an image obtained by the photographing on a predetermined sheet and then delivered to the customer at the time of the photographing, when the image is ordered by the customer possessing the order sheet; and
a processing component for performing a predetermined process corresponding to the customer's order for the image, using the image data of the ordered image which was specified by the information acquired by the acquisition component, among the image data stored in the storage device.

12. The order processing apparatus of claim 11, further comprising at least one of:
a read-out component for reading out, from a recording medium, image data recorded once on the recording medium by the image photographing apparatus, and a receiving component for receiving image data transmitted by the image photographing apparatus;
wherein the storage device stores therein the image data read out by the read-out component, or the image data received by the reception component.

13. The order processing apparatus of claim 11, wherein the image photographing apparatus is the image photographing apparatus of claim 1, and the acquisition component acquires the information for specifying the ordered image by reading the identification information recorded on the order sheet.

14. The order processing apparatus of claim 11, wherein the image photographing apparatus is the image photographing apparatus of claim 3, and the acquisition component acquires the information for specifying the ordered image by at least one of
electrically reading the identification information recorded in an IC chip of the order sheet by the recording component,
magnetically reading the identification information recorded on a magnetic medium disposed on the order sheet in advanve, and
optically reading a code recorded as the identification information on the order sheet.

15. The order processing apparatus of claim 11, wherein:
the acquisition component acquires read results of the order sheet as the information for specifying the ordered image by at least one of reading the order sheet and receiving the read results of the order sheet from a reading component; and
the processing component specifies the ordered image by analyzing the read result of the order sheet acquired by the acquisition component.

16. The order processing apparatus of claim 11, wherein:
contents of the customer's order are hand-written onto the order sheet by the customer;
the acquisition component acquires information expressing the customer's order contents by at least one of reading the order sheet, on which the order contents are hand-written, and receiving and analyzing the read result of the order sheet as read by a reading component; and
the processing component performs the predetermined process on the basis of the information representing the customer's order contents and acquired by the acquisition component.

17. The order processing apparatus of claim 11, wherein, using the image data of the image from among the image data stored in the storage device, the processing component performs as the predetermined process either a process for creating a print or for making a request for the producing of the print or a process for delivering or transmitting the image data of the ordered image to the customer.

18. An order processing method comprising the steps of:
producing an order sheet and providing the same to a customer by printing an image obtained by the photographing on a predetermined sheet, when a photograph is taken;
storing the image data obtained by the photographing in a storage device in advance;
acquiring, when the image has been ordered by the customer possessing the order sheet, information for specifying an image, which was ordered by the customer, from the order sheet;
specifying the ordered image on the basis of the acquired information;
using the image data of the ordered image, which image data is stored in the storage device, and performing a predetermined process in accordance with the order from the customer to this ordered image.

19. The order processing method of claim 18, wherein the image is a still image or a moving image.

20. The order processing method of claim 18, wherein, at the step of storing, the image data obtained by the photographing is recorded on a recording medium, and the image data recorded on the recording medium is stored in the storage device.

21. The order processing method of claim 18, wherein:
the predetermined sheet includes an electronic display medium, which can electronically retain and visibly display a written image and can rewrite the retained image;
the order sheet is produced by writing the image obtained by the photographing into the electronic display medium of the predetermined sheet;
the order sheet is collected when the image is ordered by the customer who possesses the order sheet; and
the predetermined sheet is reused by erasing the image written in the electronic display medium of the order sheet collected.
